(19) United States
(12) Patent Application Publication
(10) Pub. No.: US 2022/0305552 A1
(43) Pub. Date: Sep. 29, 2022

(54) Protein Template Dispersion, Method of Producing Protein Template Dispersion, and Method for Producing Alloy Nanoparticles

(71) Applicant: Nippon Telegraph and Telephone Corporation, Tokyo (JP)

(72) Inventors: Mikayo Iwata, Musashino-shi, Tokyo (JP); Masaya Nohara, Musashino-shi, Tokyo (JP); Hiroaki Taguchi, Musashino-shi, Tokyo (JP); Takeshi Komatsu, Musashino-shi, Tokyo (JP)

(21) Appl. No.: 17/604,874

(22) PCT Filed: May 15, 2019
(86) PCT No.: PCT/JP2019/019326

§ 371 Date: Oct. 19, 2021

(51) Int. Cl. B22F 1/054; B22F 9/26; B82Y 40/00

(52) U.S. Cl. CPC B22F 1/054; B22F 9/26; B82Y 40/00

(57) ABSTRACT

A protein template dispersion solution of the present embodiment includes a protein template containing two or more types of heterogeneous metal ions or alloy nanoparticles; and a solvent in which the protein template is dispersed, wherein alloy nanoparticles are obtained by removing the protein template. A method of producing a protein template dispersion solution according to the present embodiment includes: a step in which a protein template is added to a solution in which heterogeneous metal ions are dissolved and metal ions are introduced into the protein template; and a step in which the protein template and metal ions that are not incorporated into the protein template are separated. A method of producing alloy nanoparticles according to the present embodiment includes a step in which a dispersion solution of heterogeneous metal-ion-containing protein templates is subjected to a heat treatment under a reducing atmosphere to remove a protein template.

### TECHNICAL FIELD

The present invention relates to a technique for synthesizing alloy nanoparticles.

### BACKGROUND ART

Research has been actively conducted to make metals into nanoparticles. When metals are made into nanoparticles, unique properties such as a decrease in a melting point, a change in an absorption wavelength, and high activity as a catalyst are exhibited. For example, in the field of electrochemistry, it is widely known that, when precious metal nanoparticles such as platinum are supported on a carbon electrode, the activity with respect to a desired reaction becomes high (NPL 1). However, since precious metals such as platinum are expensive, there is a demand for an electrode having high activity using cheaper metals. Improvement in activity according to making a catalyst into nanoparticles and high dispersion when a metal other than platinum is used as a highly active catalyst has been studied (NPL 2).

In recent years, research on alloy nanoparticles has also been conducted. NPL 3 reports generation of alloy nanoparticles having an electron state of rhodium, which is the element between ruthenium and palladium on the periodic table, according to alloying of ruthenium and palladium. It has been said that ruthenium and palladium are easily phase-separated in a bulk state, and are unlikely to be alloyed also in a liquid state at 2000° C. or higher, but due to the nano-size effect, alloys at the atomic level have been realized. These alloy nanoparticles are beneficial not only because they exhibit new properties but also because cost is reduced to about one-third that of rhodium. In this manner, alloy nanoparticles are becoming more important in the search for new materials.

### CITATION LIST

### Non Patent Literature

[NPL 1] S. Alayoglu et al., “Ru—Pt core-shell nanoparticles for preferential oxidation of carbon monoxide in hydrogen”, Nature materials, APRIL 2008, Vol. 7, pp. 333-338
Y. Guo et al., “Compatibility and thermal decomposition mechanism of nitrocellulose/Cr2O3 nanoparticles studied using DSC and TG-FTIR”, RSC Advances, 2019, 9, 3927
K. Kusada et al., “Solid Solution Alloy Nanoparticles of Immiscible Pd and Ru Elements Neighboring on Rh: Changeover of the Thermodynamic Behavior for Hydrogen Storage and Enhanced CO-Oxidizing Ability”, Journal of the American Chemical Society, 2014, 136, 1864-1871

### SUMMARY OF THE INVENTION

### Technical Problem

The conventional general nanoparticle generation method is a method of dissolving a salt containing desired metal ions and adding a reducing agent. However, in the conventional method, aggregation of nanoparticles is likely to occur, and the particle size tends to vary from several nm to several tens of nm. Therefore, a method of synthesizing a uniform particle size has been a problem.

In addition, in alloying of nanoparticles, in addition to particle size control, in the case of metals that are easily phase-separated in the bulk state, there is a problem that these metals are separated during particle precipitation and cannot be alloyed.

The present invention has been made in view of the above circumstances and an object of the present invention is to produce alloy nanoparticles having a uniform particle size in a combination of easily separable metals.

### Means for Solving the Problem

A protein template dispersion solution according to the present embodiment includes a protein template containing two or more types of heterogeneous metal ions or alloy nanoparticles, and a solvent in which the protein template is dispersed, wherein alloy nanoparticles are obtained by removing the protein template.

A method of producing a protein template dispersion solution according to the present embodiment includes a step in which a protein template is added to a solution in which metal ions of desired alloy nanoparticles are dissolved, and the metal ions are introduced into the protein template; and a step in which the protein template and metal ions that are not incorporated into the protein template are separated.

A method of producing alloy nanoparticles according to the present embodiment includes a step in which a protein template dispersion solution containing two or more types of heterogeneous metal ions is subjected to a heat treatment under a reducing atmosphere to remove a protein template.

A method of producing alloy nanoparticles according to the present embodiment includes a step in which a dispersion solution of protein templates containing alloy nanoparticles is subjected to a heat treatment, an ultraviolet ray treatment, a radiation treatment, or a plasma treatment to remove protein templates.

### Effects of the Invention

According to the present invention, it is possible to produce alloy nanoparticles having a uniform particle size in a combination of easily separable metals.

### BRIEF DESCRIPTION OF DRAWINGS

FIG. 1 is a flowchart illustrating a method of producing a dispersion solution of heterogeneous metal-ion-containing protein templates according to the present embodiment.

FIG. 2A is a flowchart illustrating a method of producing a dispersion solution of alloy-nanoparticle-containing protein templates according to the present embodiment.

FIG. 2B is a flowchart illustrating a method of producing a dispersion solution of alloy-nanoparticle-containing protein templates according to the present embodiment.

FIG. 3A is a flowchart illustrating a method of producing alloy nanoparticles using a protein template.

FIG. 3B is a flowchart illustrating a method of producing alloy nanoparticles using a protein template.

FIG. 3C is a flowchart illustrating a method of producing alloy nanoparticles using a protein template.

FIG. 4 is an SEM image of alloy nanoparticles produced by the production method of the present embodiment.

FIG. 5 is an SEM image of nanoparticles produced by a production method of a comparative example.

### DESCRIPTION OF EMBODIMENTS

Embodiments of the present invention will be described below with reference to the drawings.

### (Method of Producing Dispersion Solution of Heterogeneous Metal-Ion-Containing Protein)

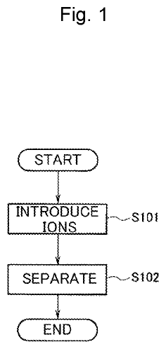

A method of producing a dispersion solution of heterogeneous metal-ion-containing protein templates will be described with reference to FIG. 1.

The method of producing a dispersion solution of heterogeneous metal-ion-containing protein templates according to the present embodiment includes an ion introduction step and a separation step.

In the ion introduction step of Step S101, a salt containing metal ions of desired alloy nanoparticles is dissolved in a solvent, a protein template is added to the solution, and metal ions are introduced into the protein template.

The combination of metal ions is preferably any one combination of Fe—Cu, Ru—Pd, Rh—Ag, Cd—Sn, Zn—Ge, Pd—Pt, Ru—Pt, Rh—(Cu,Ni,Co,Fe), and Pt—(Cu,Ni,Co,Fe). When the combination of metal ions is a combination of iron ions and copper ions, alloy nanoparticles having the same properties as those of nickel and cobalt can be produced. When the combination of metal ions is a combination of ruthenium ions and palladium ions, a combination of rhodium ions and silver ions, a combination of cadmium ions and tin ions, or a combination of zinc ions and germanium ions, alloy nanoparticles having the same properties as those of rhodium, palladium, indium, and gallium can be produced. Palladium, platinum, and ruthenium are known to have high activity as catalysts. When the combination of metal ions is a combination of palladium ions and platinum ions or a combination of ruthenium ions and platinum ions, a material having higher activity can be produced. When the combination of metal ions is a combination of rhodium ions and any one of copper, nickel, cobalt and iron ions, or a combination of platinum ions and any one of copper, nickel, cobalt and iron ions, and rhodium or platinum is alloyed with a transition metal, alloy nanoparticles having high activity with respect to an oxygen reduction reaction can be produced by an electronic interaction between transition metals while reducing an amount of expensive rhodium and platinum used.

Examples of the type of solvent include an inorganic type such as water, hydrochloric acid, a sodium hydroxide aqueous solution, a potassium hydroxide aqueous solution, a potassium chloride aqueous solution, phosphoric acid, a phosphate buffer solution, and a biochemical buffer solution (PBS, HEPES, trishydroxymethylaminomethane) and an organic type such as glycol, carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, and glycerin. The type thereof is not limited as long as a protein can maintain its shape as a multimer having a hollow part containing a precursor of metal nanoparticles. In addition, two or more types of these solvents may be mixed.

As the type of salt to be dissolved, general salts that are soluble in a solvent such as metal oxides, metal hydroxides, metal chlorides, metal sulfates, metal nitrates, metal carbonates, and organic metal salts of water-soluble metals can be used. In this case, the pH of the solution changes depending on the solvent and salt used, but if the pH is high (basic), since precipitation of hydroxides and the like may occur, those containing heterogeneous metal ions are not appropriate. In addition, when the pH of the solution excessively changes, such as a strong base or a strong acid, a protein to be added later may be denatured. This is because a charged state of a charged polar group (glutamic acid, aspartic acid, lysine, arginine, histidine) on the surface or inside of the protein changes, and stress is applied between charged particles. Therefore, when the structure of the protein changes depending on the pH, it is necessary to adjust the pH before a protein is added using a solution of a strong acid or a strong base.

Examples of protein templates include ferritin proteins, heat shock proteins, DpsA proteins, capsid proteins (adenovirus, rotavirus, poliovirus, HK97 virus, Cowpea chlorotic mottle virus (CCMV), Cowpea mosaic virus (CPMV) and viruses selected from the group consisting of variants thereof and the like), or variants obtained by modifying amino acid sequences thereof. When these proteins are used, the coefficient of variation in particle size of the finally obtained alloy nanoparticles is 1% to 15%, which indicates high uniformity. The particle size of the alloy nanoparticles can be a value of about 2 to 18 nm depending on the type of proteins used.

In the separation step of Step S102, proteins and metal ions not incorporated into proteins are separated to obtain a dispersion solution of protein templates containing heterogeneous metal ions.

The heterogeneous metal-ion-containing protein obtained in the ion introduction step is dispersed in a solution in which metal ions are dissolved. Dialysis or gel filtration column chromatography is performed in order to separate proteins having a large molecular weight.

When dialysis is performed, a sample to be separated is filled into a dialysis tube, and immersed in deionized water as a dialysis buffer for 1 to 5 hours, and preferably 1 to 2 hours. After immersion, the deionized water is replaced, dialysis is additionally performed for 1 to 2 hours, the deionized water is replaced, dialysis is performed overnight, and thereby the protein having a large molecular weight remains inside the dialysis tube. Thereby, a dispersion solution of protein templates containing heterogeneous metal ions can be obtained.

When gel filtration column chromatography is used, it is possible to separate proteins using a commercially available gel filtration carrier and column. The gel filtration column chromatography is a typical method used for purifying biomolecules such as proteins and diffusions. Gel filtration column chromatography is a separation method using a difference in molecular weight. Since molecules having a small molecular weight enter pores in carriers in the column, the time for which they pass through the column becomes longer, and since molecules having a large molecular weight do not enter pores, the time for which they pass through column becomes shorter. The procedure includes preparation of a running buffer (dust is removed through a filter), equilibration of a column (a buffer flows through a column), addition of a sample (an amount of sample suitable for the column is added, and addition is performed at a flow rate that does not break the limit), and elution of the sample (flush a 1.2 CV buffer by a program to elute automatically). Thereby, a dispersion solution of protein templates containing heterogeneous metal ions can be obtained.

### (Method of Producing Dispersion Solution of Alloy-Nanoparticle-Containing Protein)

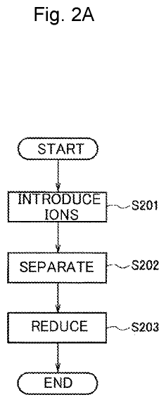

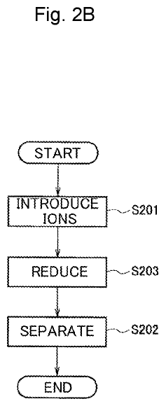

A method of producing a dispersion solution of alloy-nanoparticle-containing protein templates will be described with reference to FIGS. 2A and 2B.

A method of producing a dispersion solution of alloy-nanoparticle-containing protein templates according to the present embodiment includes an ion introduction step, a separation step, and a reduction step.

In the production method illustrated in FIG. 2A, after a dispersion solution of heterogeneous metal-ion-containing protein templates is prepared according to the ion introduction step of Step S201 and the separation step of Step S202, the reduction step of Step S203 is performed to produce a dispersion solution of alloy-nanoparticle-containing protein templates.

The ion introduction step of Step S201 and the separation step of Step S202 are same as the ion introduction step and the separation step in the method of producing a dispersion solution of heterogeneous metal-ion-containing protein templates.

In the reduction step of Step S203, heterogeneous metal ions incorporated into the protein template are reduced with a reducing agent to form alloy nanoparticles. As the reducing agent, sulfur dioxide, hydrogen sulfide, sodium sulfite, oxalic acid, sodium borohydride, potassium iodide and the like, which are used in general synthesis methods, can be used. The concentration and amount of the reducing agent are determined according to the amount and type of the heterogeneous metal-ion-containing protein template.

As illustrated in FIG. 2B, after metal ions are introduced into protein inner shells in the ion introduction step of Step S201, the reduction step of Step S203 may be performed, and the separation step of Step S202 may be performed after the reduction step.

### (Method of Producing Alloy Nanoparticles)

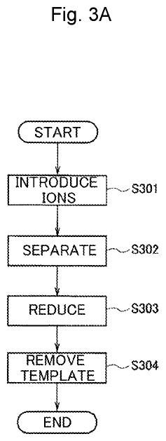

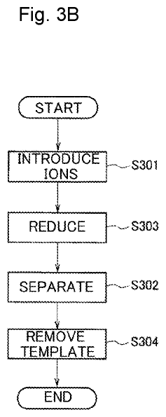

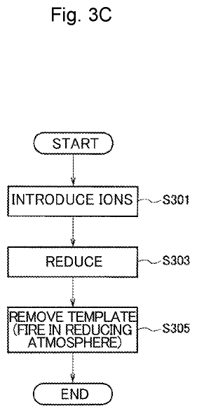

A method of producing alloy nanoparticles using a protein template will be described with reference to FIGS. 3A to 3C. The method of producing alloy nanoparticles according to the present embodiment includes an ion introduction step, a separation step, a reduction step, and a template removal step.

First, the production method illustrated in FIGS. 3A and 3B will be described. In the production method illustrated in FIGS. 3A and 3B, after a dispersion solution of alloy-nanoparticle-containing protein templates is prepared according to the ion introduction step of Step S301, the separation step of Step S302, and the reduction step of Step S303, the template removal step of Step S304 is performed to produce alloy nanoparticles.

The ion introduction step of Step S301, the separation step of Step S302, and the reduction step of Step S303 are the same as the ion introduction step, the separation step, and the reduction step in FIG. 2A or FIG. 2B. The order of the separation step and the reduction step is different between the production method in FIG. 3A and the production method in FIG. 3B.

In the template removal step of Step S304, proteins that are templates containing alloy nanoparticles are removed. For example, proteins that are organic substances are removed by the heat treatment, UV emission, plasma emission, or radiation (electron beam, gamma rays) emission.

When templates are removed by the heat treatment, the templates are removed by firing at 100° C. to 2000° C., and more preferably at 100° C. to 800° C. The atmosphere in the furnace may be oxygen or air, or may be an inert gas, for example, ammonia gas, nitrogen oxide gas, nitrogen gas, argon gas, helium gas, carbon dioxide gas, or the like. In order to prevent separation of alloy nanoparticles due to heating, it is preferable to set the atmosphere in the furnace as an inert gas atmosphere and remove the templates by carbonizing.

When templates are removed by UV emission, a dispersion solution of protein templates containing alloy nanoparticles is added dropwise to a substrate formed of an inorganic substance (for example, a glass substrate, a silicon substrate, or the like) or a matrix on which alloy nanoparticles are to be supported. The matrix such as a substrate may be dipped in the dispersion solution. The matrix to which the dispersion solution is added dropwise is put into a UV emission device (a device that simultaneously generates ultraviolet rays having wavelengths of 185 nm and 254 nm), and ultraviolet rays are emitted for 10 to 150 minutes, and preferably 30 to 60 minutes. When a temperature variable mechanism is provided for the UV emission device, the treatment may be performed while heating at about 100° C. to 150° C.

When templates are removed by plasma emission, as in UV emission, a dispersion solution of protein templates containing alloy nanoparticles is added dropwise to a matrix such as a substrate (may be dipped). Plasma is emitted to the matrix to which the dispersion solution is added dropwise for 10 to 200 minutes, and preferably 100 to 150 minutes.

When templates are removed by radiation emission, as in UV emission, a dispersion solution of protein templates containing alloy nanoparticles is added dropwise to (may be dipped in) a matrix such as a substrate. An electron beam at a dose of about 20 kGy is emitted to the matrix to which the dispersion solution is added dropwise for 1 to 20 seconds. Alternatively, gamma rays at a dose of about 10 to 30 kGy are emitted to the matrix to which the dispersion solution is added dropwise for 1 to 5 hours.

Next, the production method illustrated in FIG. 3C will be described. In the production method illustrated in FIG. 3C, after the ion introduction step of Step S301, the template removal step of Step S305 is performed under a reducing atmosphere while the reduction step of Step S303 is performed.

The ion introduction step of Step S301 is the same as the ion introduction step in the method of producing a dispersion solution of alloy-nanoparticle-containing protein templates.

In the template removal step of Step S305, the atmosphere in the furnace during the heat treatment is set as a reducing gas such as hydrogen gas and carbon monoxide gas, and the protein templates are removed while performing reducing. When the atmosphere in the furnace is set as a reducing gas, since the protein templates can be removed while performing reducing, the separation step can be omitted.

Next, Examples 1 to 3 in which a dispersion solution of heterogeneous metal-ion-containing protein templates, a dispersion solution of alloy-nanoparticle-containing protein templates, and alloy nanoparticles are produced according to the above production method will be described.

### Example 1

As Example 1, an example in which a commercially available apoferritin solution (commercially available from Tokyo Chemical Industry Co., Ltd.) was used as template proteins, iron ions and copper ions were used as metal ions, and a dispersion solution of heterogeneous metal-ion-containing protein templates was prepared according to the production method in FIG. 1 is shown. Desired alloy nanoparticles could be prepared by replacing apoferritin with another material and replacing iron ions and copper ions with other metal ions.

The apoferritin solution had a form of ferritin having no ferrihydrite stored in the inner shell of ferritin. In this example, an apoferritin solution obtained by diluting a commercially available apoferritin solution with a HEPES buffer solution to 10 wt % was used. The commercially available apoferritin solution was collected from a horse's spleen and contained proteins composed of the elements C, H, O, N, S, and the like. Commercially available apoferritin solutions with concentrations adjusted to 100 mg/l mL are being sold.

In the ion introduction step of Step S101, 50 mL of water was put into a 100 mL beaker, 10 mmol/L of each of ferric chloride powder [commercially available from Kanto Chemical Co., Inc.] and copper sulfate pentahydrate powder [commercially available from Kanto Chemical Co., Inc.] was added, and the mixture was stirred for 10 minutes to prepare a solution in which iron ions and copper ions were dissolved. Since the pH of the solution was about 3, 0.2 mol/L sodium hydroxide was added to the solution, and the pH was adjusted to about 7. 1 mL of 1 μmol/L apoferritin was added thereto and the mixture was stirred for 60 minutes.

In the separation step of Step S102, gel filtration column chromatography was performed using Sephadex G-25 (commercially available from GE Healthcare) as a column and deionized water as a buffer. Since the molecular weight of apoferritin was 440,000, gel filtration column chromatography and dialysis using the size of molecular weight were effective for separation from metal ions.

According to the above steps, a protein template dispersion solution containing iron ions and copper ions was obtained.

### Example 2

As Example 2, an example in which a protein template dispersion solution containing iron ions and copper ions was reduced by the production method in FIG. 2A to prepare a dispersion solution of alloy-nanoparticle-containing protein templates is shown.

The ion introduction step of Step S201 and the separation step of Step S202 were the same as those of Example 1. In Example 2, the dispersion solution prepared in Example 1 was used.

In the reduction step of Step S203, 150 μL of 0.2 mol/L sodium borohydride was added as a reducing agent to the dispersion solution prepared in Example 1. Then, it was visually confirmed that the color of the solution changed and the reduction reaction occurred. This is because heterogeneous metal ions were made into alloy nanoparticles due to the reduction of metal ions.

When the protein template dispersion solution containing iron ions and copper ions was reduced, a protein template dispersion solution containing alloy nanoparticles was obtained.

Here, as in the production method in FIG. 2B, before the separation step, the above reduction step may be performed when metal ions and proteins are present in the solution, and the separation step may be performed after the reduction step.

### Example 3

As Example 3, an example in which alloy nanoparticles were produced while reducing the dispersion solution of heterogeneous metal-ion-containing protein templates prepared in Example 1 and an example in which alloy nanoparticles were produced from the dispersion solution of alloy-nanoparticle-containing protein templates prepared in Example 2 are shown.

First, an example in which alloy nanoparticles were produced while reducing the dispersion solution of heterogeneous metal-ion-containing protein templates according to the production method in FIG. 3C will be described. Here, the dispersion solution prepared in Example 1 was used.

The ion introduction step of Step S301 was the same as that of Example 1. While the dispersion solution prepared in Example 1 was subjected to the separation step, the separation step may not be performed in the production method in FIG. 3C.

In the reduction step of Step S303 and the template removal step of Step S305, first, commercially available carbon (Ketjen Black EC600JD, commercially available from Lion Corporation) was dispersed to 10 wt % in deionized water. A dispersion solution in which the heterogeneous metal-ion-containing protein template was dispersed was added dropwise to deionized water in which carbon was dispersed so that the weight ratio of solid contents (weight ratio between carbon and protein templates) was 8:2, and the mixture was sufficiently mixed using a kneading machine. The solution mixed with the dispersion solution was put into an alumina crucible and fired in an electric furnace at a heating rate of 4° C./min and at 600° C. for 3 hours in a hydrogen atmosphere.

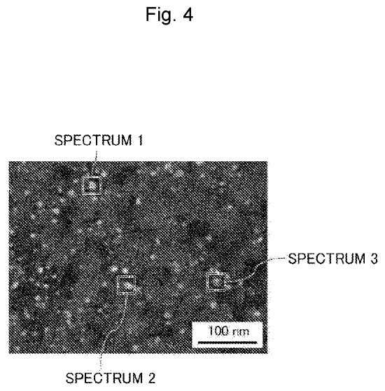

After firing, according to observation under a scanning electron microscope (SEM), it was confirmed that nanoparticles having a uniform particle size could be supported with high dispersion. FIG. 4 shows an SEM image of alloy nanoparticles. When elemental analysis was performed on nanoparticles illustrated in spectrums 1 to 3 in FIG. 4 through energy-dispersive X-ray spectroscopy (EDS), as shown in Table 1 below, iron and copper were detected in each particle to about the same extent.

TABLE 1

| Spectrum label | Spectrum 1 | Spectrum 2 | Spectrum 3 |
|---|---|---|---|
| C | 89.16 | 92.34 | 90.14 |
| Fe | 5.58 | 3.41 | 5.22 |
| Cu | 5.26 | 4.25 | 4.64 |
| Total | 100 | 100 | 100 |

In this manner, when a small amount of the dispersion solution of heterogeneous metal-ion-containing protein templates was added to the matrix to which particles were to be supported and mixed, and then fired in a reducing atmosphere, it was possible to support alloy nanoparticles having a uniform particle size with high dispersion.

Next, an example in which alloy nanoparticles were produced from the dispersion solution of alloy-nanoparticle-containing protein templates according to the production method in FIG. 3A will be described. Here, the dispersion solution of alloy-nanoparticle-containing protein templates prepared in Example 2 was used.

The ion introduction step of Step S301, the separation step of Step S302, and the reduction step of Step S303 were the same those of Examples 1 and 2. In the production method in FIG. 3B, when the dispersion solution of alloy-nanoparticle-containing protein templates was produced, the order of the separation step of Step S302 and the reduction step of Step S303 was reversed.

In the template removal step of Step S304, one drop of the dispersion solution was added dropwise to a commercially available quartz glass substrate having a size of 15×15 mm, the quartz glass substrate was arranged in a UV emission device (commercially available from Filgen, Inc.), and ultraviolet rays were emitted for 30 minutes. Here, the protein templates may be removed by the heat treatment.

After UV emission, when the sample was observed through SEM and EDS, alloy nanoparticles having a uniform particle size were confirmed.

### Comparative Example

Next, production of alloy nanoparticles of a comparative example will be described.

In the comparative example, without using protein templates, reduction was performed while 10 mmol/L of copper ions and iron ions were dissolved in 50 mL of a solvent (deionized water) put into a beaker to produce nanoparticles. Since the obtained nanoparticles were dispersed in the solution, this was used as a dispersion solution.

As in Example 3, deionized water in which carbon (10 wt %) was dispersed was prepared, a dispersion solution was added so that the weight ratio of the solid content to carbon was 8:2, and the mixture was sufficiently mixed using a kneading machine. The solution mixed with the dispersion solution was put into an alumina crucible and fired in an electric furnace at a heating rate 4° C./min and at 600° C. for 3 hours in a hydrogen atmosphere.

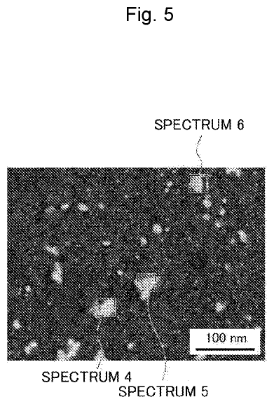

After firing, according to observation under an SEM, it was confirmed that nanoparticles having a non-uniform particle size were supported. FIG. 5 shows an SEM image of the nanoparticles of the comparative example. When elemental analysis was performed on nanoparticles illustrated in spectrums 4 to 6 in FIG. 5 through EDS analysis, as shown in Table 2 below, in the particles, either elemental iron or copper was dominant. That is, it suggests that iron and copper were not alloyed but a mixture of iron particles and copper particles was formed. This is thought to be caused by the fact that iron and copper are metal species that are difficult to alloy.

TABLE 2

| Spectrum label | Spectrum 4 | Spectrum 5 | Spectrum 6 |
|---|---|---|---|
| C | 82.14 | 85.63 | 86.31 |
| Fe | 0.03 | 14.36 | 12.93 |
| Cu | 17.83 | 0.01 | 0.76 |
| Total | 100 | 100 | 100 |

### (Measurement Results of Alloy Nanoparticles)

Alloy nanoparticles of iron and copper were produced according to Examples 1 to 3 by changing the type of proteins and the particle size of the nanoparticles was measured. Table 3 shows the type of proteins, the inner diameter of proteins, the particle size of the nanoparticles, the coefficient of variation indicating the variation in particle size, and whether they were alloyed together. Table 3 also shows measurement results of the nanoparticles synthesized in the comparative example in which iron ions and copper ions were mixed without using proteins.

TABLE 3

| | Inner | Particle | | |
|---|---|---|---|---|
| | diameter | size of | Coefficient | |
| | of protein | nanoparticle | of variation | |
| Protein | (nm) | (nm) | (%) | Alloyed |
| Ferritin | 8 | 4 to 8 | 11 | OK |
| Heat shock | 6.5 | 2 to 6 | 8 | OK |
| protein | | | | |
| DpsA | 4.5 | 2 to 4 | 5 | OK |
| protein | | | | |
| Capsid | 12 to 18 | 5 to 15 | 13 | OK |
| protein | | | | |
| Comparative | — | 5 to 80 | 50 | NG |
| example | | | | |

In Table 3, it can be understood that, in the present embodiment using proteins, alloy nanoparticles having a particle size equal to or smaller than the inner diameter of the protein were obtained. It can be understood that, since a difference in amount of metal ions contained in the protein template was less likely to occur as the inner diameter of the protein was smaller, the uniformity became higher and the coefficient of variation was smaller. In addition, when alloy nanoparticles were synthesized using nanospaces of proteins, it was possible to produce an alloy of metal species that were considered difficult to synthesize in the related art.

The nanoparticles produced by the production method of the comparative example had a particle size of 5 to 80 nm, which was widely distributed, and had a coefficient of variation of 50%. In the comparative example, metal particles were separated into iron and copper and could not be alloyed.

As described above, according to the present embodiment, protein templates were dispersed in a solution in which two or more types of heterogeneous metal ions were present, metal ions were incorporated into the protein templates, the solution was then reduced, the solution and the proteins were separated, the proteins were then removed, and thereby alloy nanoparticles having a uniform particle size were able to be obtained.

Here, the present invention is not limited to the embodiments described above, and it can be clearly understood that many modifications and combinations can be made within the technical scope of the present invention by those skilled in the art.

1. A protein template dispersion solution, comprising:
a protein template containing two or more types of heterogeneous metal ions or alloy nanoparticles; and
a solvent in which the protein template is dispersed, wherein alloy nanoparticles are obtained by removing the protein template.

2. The protein template dispersion solution according to claim 1, wherein the protein template is composed of any one of a ferritin protein, a heat shock protein, a DpsA protein, a capsid protein, or a variant obtained by modifying an amino acid sequence thereof.

3. The protein template dispersion solution according to claim 1, wherein the alloy nanoparticles have a particle size of 2 nm or more and 18 nm or less, and the coefficient of variation in particle size is 1% or more and 15% or less.

4. The protein template dispersion solution according to claim 1, wherein a combination of the heterogeneous metal ions is any one of a combination of: iron ions and copper ions; a combination of ruthenium ions and palladium ions; a combination of rhodium ions and silver ions; a combination of cadmium ions and tin ions; a combination of zinc ions and germanium ions; a combination of palladium ions and platinum ions; a combination of ruthenium ions and platinum ions; a combination of rhodium ions and any one of copper, nickel, cobalt and iron ions; or a combination of platinum ions and any of copper, nickel, cobalt and iron ions.

5. A method of producing a protein template dispersion solution, comprising:
a step in which a protein template is added to a solution in which metal ions of desired alloy nanoparticles are dissolved and the metal ions are introduced into the protein template; and
a step in which the protein template and metal ions that are not incorporated into the protein template are separated.

6. The method of producing a protein template dispersion solution according to claim 5, including a step in which the metal ions incorporated into the protein template are reduced.

7. A method of producing alloy nanoparticles, comprising: a step in which a protein template dispersion solution containing two or more types of heterogeneous metal ions is subjected to a heat treatment under a reducing atmosphere to remove a protein template.

8. (canceled)

9. The protein template dispersion solution according to claim 2, wherein the alloy nanoparticles have a particle size of 2 nm or more and 18 nm or less, and the coefficient of variation in particle size is 1% or more and 15% or less.

10. The protein template dispersion solution according to claim 2, wherein a combination of the heterogeneous metal ions is any one of a combination of: iron ions and copper ions; a combination of ruthenium ions and palladium ions; a combination of rhodium ions and silver ions; a combination of cadmium ions and tin ions; a combination of zinc ions and germanium ions; a combination of palladium ions and platinum ions; a combination of ruthenium ions and platinum ions; a combination of rhodium ions and any one of copper, nickel, cobalt and iron ions; or a combination of platinum ions and any of copper, nickel, cobalt and iron ions.

11. The protein template dispersion solution according to claim 3, wherein a combination of the heterogeneous metal ions is any one of a combination of: iron ions and copper ions; a combination of ruthenium ions and palladium ions; a combination of rhodium ions and silver ions; a combination of cadmium ions and tin ions; a combination of zinc ions and germanium ions; a combination of palladium ions and platinum ions; a combination of ruthenium ions and platinum ions; a combination of rhodium ions and any one of copper, nickel, cobalt and iron ions; or a combination of platinum ions and any of copper, nickel, cobalt and iron ions.
